(19) United States
(12) Patent Application Publication
(10) Pub. No.: US 2013/0305332 A1
(43) Pub. Date: Nov. 14, 2013

(54) System and Method for Providing Data Link Layer and Network Layer Mobility Using Leveled Security Keys

(71) Applicants: Partha Narasimhan, Saratoga, CA (US); Venkatesh Joshi, Bangalore (IN); Juei-Cheng Lo, Los Altos, CA (US)

(72) Inventors: Partha Narasimhan, Saratoga, CA (US); Venkatesh Joshi, Bangalore (IN); Juei-Cheng Lo, Los Altos, CA (US)

(21) Appl. No.: 13/466,742

(22) Filed: May 8, 2012

(51) Int. Cl. G06F 21/20

(52) U.S. Cl. 726/7

(57) ABSTRACT

The present disclosure discloses a network device and/or method for providing data link layer (L2) and network layer (L3) mobility using level security keys. A first network device acting as a first level security key holder in a first network receives a first level security key holder identifier corresponding to a second network device in a second network. The first level security key holder identifier is originated from a client that roams from the second network to the first network. Moreover, the first network and the second network belong to a single roaming domain. Also, the network device transmits the first level security key holder identifier to the second network device and requests for corresponding first level security key. The network device then derives a second level security key and transmits a second level security key identifier the second level key holder in the first network.

### RELATED APPLICATIONS

The present application is related co-pending application entitled “Propagation of Leveled Key to Neighborhood Network Devices” (Attorney Docket No. 6259P144) by Partha Narasimhan, Venkatesh Joshi, and Juei-Cheng Lo, U.S. patent application Ser. No. 13/363,087, filed on 31 Jan. 2012, and is related to co-pending application entitled “System and Method for Determining Leveled Security Key Holder” (Attorney Docket No. 6259P145) by Partha Narasimhan, Venkatesh Joshi, and Juei-Cheng Lo, U.S. patent application Ser. No. 13/368,212, filed on 7 Feb. 2012, the entire contents of which are both incorporated by reference herein.

### FIELD

The present disclosure relates to wireless mobile device handoffs in a wireless digital network. In particular, the present disclosure relates to fast Basic Service Set (BSS) transitions (FT) mechanisms between access points in a wireless digital network.

### BACKGROUND

Wireless digital networks, such as networks operating under the current Institute of Electrical and Electronics Engineers (IEEE) 802.11 standards, are spreading in their popularity and availability. With such popularity, however, come problems involving fast BSS transitions. A BSS transition generally refers to movement of a wireless station from one BSS in one extended service set (ESS) to another BSS within the same ESS. By contrast, a fast BSS transition (FT) generally refers to a BSS transition that establishes the state necessary for data connectivity before the wireless station initiates a re-association rather than after the wireless station initiates the re-association.

For example, the current IEEE 802.111 standard (Medium Access Control Security Enhancements) provides pre-authentication and Pairwise Master Key (PMK) caching. Pre-authentication enables supplicants, such as wireless stations, to authenticate with authenticators, such as access points or network controllers, to which they may roam. Pre-authentication typically happens through the access point to which the wireless station is currently associated over a distribution system, such as an Ethernet network. Moreover, PMK caching allows supplicants and authenticators to cache PMK Security Associations (PMKSAs) so that a supplicant revisiting an authenticator to which it has previously authenticated can omit performing IEEE 802.1X/EAP authentications and proceed directly to a 4-way handshake. The 4-way handshake is used by an IEEE 802.1X supplicant and an authenticator to derive Pairwise Transient Keys (PTKs) which are used for encrypting data frames. PMK Caching is also referred to as “fast roam-back” because supplicants have previously authenticated and formed a PMKSA with the authenticator in order to proceed directly to the 4-way handshake.

Alternatively, an Opportunistic Key Caching (OKC) protocol can be used in fast roaming where the supplicant has never authenticated. OKC allows the PMK in the initial PMKSA formed by the supplicant and authenticator to be reused across the network. The PMK can be redistributed by a wireless local area network (WLAN) and given new PMK identifiers that are unique to each access point in the WLAN. The unique PMK identifier may include the new access point's Media Access Control (MAC) address (or BSSID). According to OKC, the supplicant places the unique PMK identifier into its re-association request; and when the authenticator validates the PMK identifier, the access point starts the 4-way handshake using the PMK corresponding to the PMK identifier to derive a PTK.

Moreover, the current IEEE 802.11r standard (Fast Basic Service Set Transition) specifies an exemplary FT protocol, which redefines a security key negotiation protocol and allows the negotiation and request for wireless resources to occur in parallel. The IEEE 802.11r standard introduces, inter alia, a new 3-tier authentication and key management (AKM) architecture and two tiers of pairwise master keys (PMKs). Furthermore, according to IEEE 802.11r standard, a Mobility Domain is typically a set of BSSs within the same ESS, each of which is identified by a Mobility Domain identifier. Fast BSS Transition (FT) can be supported between access points within a Mobility Domain, but is not specified between Mobility Domains according to the IEEE 802.11r standard. Also, an authenticator is split into two levels: a first level key holder, such as a PMK-R0 Key Holder (R0KH), and a second level key holder, such as a PMK-R1 Key Holder (R1KH).

Nevertheless, existing protocols supporting fast BSS transitions barely provide any effective and efficient way of propagating leveled security keys to enable the fast BSS transitions. Proactive propagation of leveled security keys from a first level key holder to an appropriate second level key holder can accelerate time required for completion of the fast BSS transition, and thereby provide Open Systems Interconnect (OSI) Layer 2 (i.e. data link layer) mobility. Therefore, a station can quickly roam to another network device within the same Layer 2 network.

In large WLAN deployments, roaming domains may need to scale beyond a single VLAN to multiple VLANs. For example, if a company's wireless user moves with a handheld wireless Voice-over-IP (VoIP) device within its corporate building from one sub-network to another sub-network while on a phone call, without Layer 3 roaming enabled, the wireless user will experience a call drop when she roams, because the VoIP device will be assigned a new Layer 3 identifier (e.g., a new IP address) after it associates with a new access point in a different subnet. Accordingly, it is important to provide Layer 3 roaming in addition to Layer 2 roaming in an enterprise network environment.

Layer 3 (i.e. network layer) mobility is a superset of Layer 2 (i.e. data link layer) mobility. A wireless client usually performs a Layer 2 roam before it begins a Layer 3 roam. Furthermore, in Layer 3 roaming, the network is aware of a station's current association status, and thus is able to correctly route packets to and from the station in Layer 3 network across Layer 2 boundaries based on whether the station is on a home subnet or a foreign subnet. Nonetheless, it is a challenging task to provide a mobile station with fast and reliable Layer 3 roaming capabilities in addition to Layer 2 roaming capabilities.

Conventionally, Layer 3 roaming capabilities are resolved using the “Mobile IP” protocol, which is described in Internet Engineering Task Force (IETF) RFC 2002. The Mobile IP protocol allows location-independent routing of IP datagrams on the Internet. Each mobile client is identified by its home agent (HA) regardless of its current location in the Internet. While away from its home sub-network on a foreign sub-network, a mobile client is associated with a care-of address, which identifies the mobile client's current location. The Mobile IP ensures that datagrams are properly routed to and from the mobile client through the home agent (HA) irrespective of the mobile client's current location within the network. Note that, in Mobile IP, each mobile device needs a temporary care-of address (COA) while on a foreign network (FN). The co-located care-of address is an address that is assigned directly to the mobile node (MN). Movement of wireless MNs are achieved by receiving advertisements from the FA and by subsequently registering their care-of address with the HA. This process is performed every time the MN crosses the boundary of the foreign network. Since packets destined for the MN are not delivered until registration is complete at the HA, the registration process may cause degradation in quality with real-time application, such as VoIP or video streaming applications, etc. Therefore, although mobile IP protocol enables layer 3 or network layer mobility, it will likely cause delays during roaming process, esp. when a long distance exists between the MN's home agent and foreign agent.

### BRIEF DESCRIPTION OF THE DRAWINGS

The present disclosure may be best understood by referring to the following description and accompanying drawings that are used to illustrate embodiments of the present disclosure.

FIG. 1 shows an exemplary wireless network environment according to embodiments of the present disclosure.

FIG. 2 is a block diagram illustrating an exemplary hierarchical security key management scheme used in fast BSS transition according to embodiments of the present disclosure.

FIG. 3A is a sequence diagram illustrating exemplary communication exchanges during an initial mobility domain association under fast BSS transition according to embodiments of the present disclosure.

FIG. 3B is a sequence diagram illustrating exemplary communication exchanges during wireless station roaming under fast BSS transition according to embodiments of the present disclosure.

FIGS. 4A-4B are block diagrams illustrating a method for providing data link layer and network layer mobility using leveled security key according to embodiments of the present disclosure.

FIGS. 5A-5B are sequence diagrams illustrating exemplary communication exchanges to provide data link layer and network layer mobility using leveled security key according to embodiments of the present disclosure.

FIGS. 6A-6C are flowcharts illustrating processes involved in providing data link layer and network layer mobility using leveled security according to embodiments of the present disclosure.

FIG. 7 is a block diagram illustrating a system for data link layer and network layer mobility using leveled security key according to embodiments of the present disclosure.

### DETAILED DESCRIPTION

In the following description, several specific details are presented to provide a thorough understanding. While the context of the disclosure is directed to fast BSS transition mechanisms in wireless network, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to wireless mobile device handoffs in general, and wireless network mobility during fast BSS transitions in particular.

In the solution provided herein, a first network and a second network belong to a single roaming domain. A roaming domain generally includes a collection of network entities that are capable of discovering, sharing, and/or extending a wireless client's network connectivity state. It is assumed that, a wireless client is currently associated to the second network and has not been previously associated to the first network. Furthermore, it is assumed that the wireless client has initiated the roaming procedures in accordance with the IEEE 802.11-2007 standard as it moves from the coverage area of the second network into the coverage area of the first network. The disclosed network device, acting as a first level security key holder in the first network, receives, from the wireless client, a first level security key holder identifier corresponding to a second network device present in the second network which acts as a first level security key holder in the second network.

In some embodiments, the disclosed network device in the first network, retrieves a stored value of the first level security key holder identifier corresponding to the second network device in the second network, through a request message sent to a third device in the first network. The disclosed network device then matches this value of the first level security key holder identifier with the received value of the first level security key holder identifier in order to determine whether the disclosed network device should act as a foreign agent for the wireless client under consideration.

In other embodiments, the disclosed network device in the first network identifies the second network device in the second network corresponding to the received first level security key holder identifier by checking a record that maps all the first level security key holder identifiers with the network device identifiers of network devices that are capable of acting as home agents within the same roaming domain.

In some embodiments, if it is determined that the disclosed network device in the first network should act as a foreign agent for the wireless client, in some embodiments, the disclosed network device may transmit a message containing at least the first level security key holder identifier and the Media Access Control (MAC) address of the wireless client to the second network device in the second network to request for the first level security key corresponding to the existing security association between the wireless client and the second network device in the second network. The request message will be sent securely using a proprietary protocol. The second network device in the second network will respond with a message containing at least the mac address of the wireless client and the first level security key corresponding to the security association between the wireless client and the second network device in the second network. The response message will be sent securely using a proprietary protocol.

In other embodiments, the disclosed network device determines whether the first level security key corresponding to the security association between the wireless client and the second network device in the second network is already present in its database. If so, the disclosed network device will not send a message to the second network device in the second network to request for the same.

Once the disclosed network device gets possession of the first level security key corresponding to the security association between the wireless client and the second network device in the second network, it will derive a second level security key based at least in part on the first level security key. In some embodiments, the disclosed network device will store the second level security key corresponding to the security association between the disclosed network device and the wireless client within a third network device present in the first network.

Note that the sequence of events described above may take place during the fast basic service set (BSS) transition (FT) in accordance with the IEEE 802.11r standard. Once the FT Protocol is successful, the wireless client will be deemed to have roamed over from the second network to the first network. Also, the second network device in the second network will now be regarded as the Home Agent for the wireless client while the disclosed network device in the first network to which the wireless client is now associated, will now be regarded as the Foreign Agent for the wireless client.

In some embodiments, the disclosed network device (Foreign Agent) further transmits a message consisting of one or more of an Internet Protocol (IP) address of the wireless client and a Media Access Control (MAC) address of the wireless client to the second network device (Home Agent) to notify the second network device that the wireless client has transitioned from the second network device to the first network device. The disclosed network device may also receive an acknowledgement for the message from the second network device. In some embodiments, the disclosed network device (Foreign Agent) initiates a timer after transmitting a message including one or more of the IP address and the MAC address of the client to the second network device (Home Agent). If the time expires before the disclosed network device (Foreign Agent) receives an acknowledgement back, the disclosed network device (Foreign Agent) will re-transmit the message to the second network device (Home Agent).

In some embodiments, the second network device (Home Agent) updates its routing table to redirect packets with a destination address corresponding to the wireless client's IP address, to the disclosed network device (Foreign Agent). Likewise, the disclosed network device (Foreign Agent) updates its routing table to redirect packets with a source address matching the IP address of wireless client to the second network device (Home Agent). In some embodiments, the disclosed network device (Foreign Agent) may not update its routing table to redirect packets with source IP address matching the IP address of the wireless client. It would instead rely on its routing logic to route those packets to the destination.

In some embodiments, if no first level security key corresponding to the first level security key holder identifier is received, the disclosed network device may instruct a third network device (e.g., an access point or second level key holder in the network) to de-authenticate the client or disassociate with the client.

In some embodiments, the disclosed network device receives another first level security key holder identifier from a new network device that joins the same roaming domain and is capable of acting as a home agent. The disclosed network device updates the record based at least in part on the received first level security key holder identifier and transmits the updated record to other network devices acting as first level security key holders in the single roaming domain.

In other embodiments, the disclosed network device further receives a broadcast message in network layer from the second network device within the same roaming domain. Note that, the broadcast message includes the first level security key holder identifier corresponding to the second network device. The disclosed network device then updates the record based on the broadcast message.

### Computing Environment

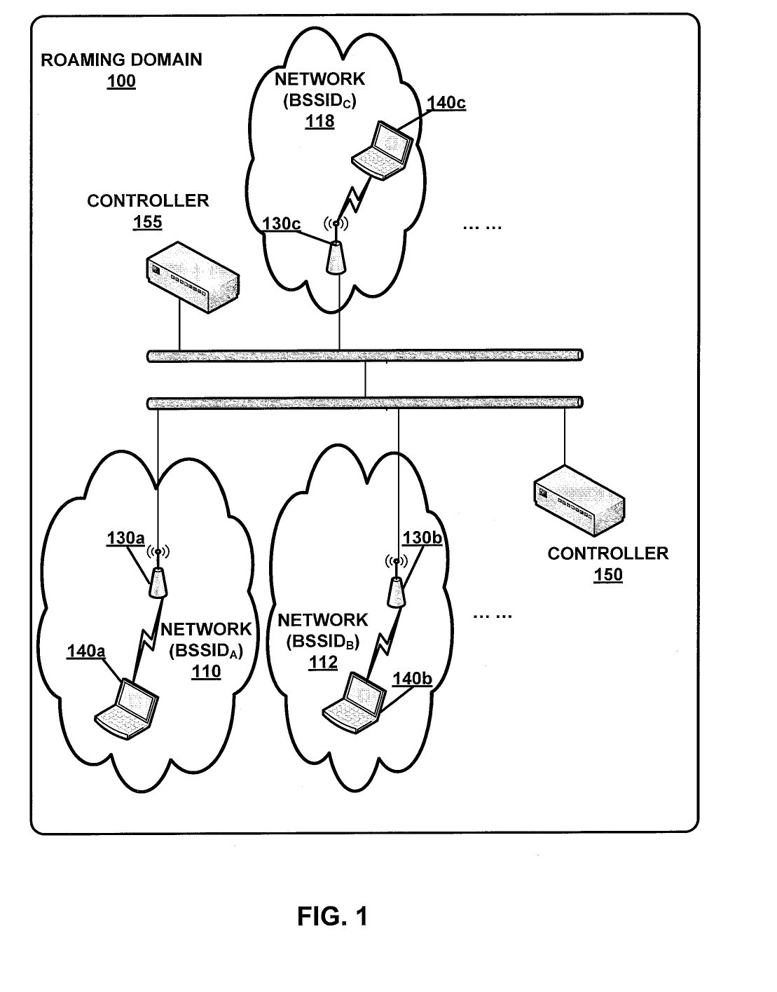

FIG. 1 shows an exemplary wireless digital network environment according to embodiments of the present disclosure. FIG. 1 includes a roaming domain 100. Roaming domain 100 includes a plurality of networks, such as network 110 (with BSSID_{A}), network 112 (with BSSID_{B}), network 118 (with BSSID_{C}) . . . . Each network may operate on a private network including one or more local area networks. The local area networks may be adapted to allow wireless access, thereby operating as a wireless local area network (WLAN). In some embodiments, one or more networks, such as networks 110 and network 112, may share the same extended service set (ESS) although each network corresponds to a unique basic service set (BSS) identifier.

In addition, roaming domain 100 may include multiple network controller devices, such as controller 150 and controller 155. Each network controller device may be located in a separate sub-network. For example, controller 150 may be located in the same sub-network or VLAN as access point 130a and access point 130b. On the other hand, controller 155 may be located in another sub-network or VLAN, which would be the same sub-network or VLAN that access point 130c belongs to.

Furthermore, each network or sub-network can additionally include one or more management network devices, such as a switch, a router, a network server, and so on. The management network devices may be located in network 110, network 112, network 118, or other similar networks within roaming domain 100.

In the example illustrated in FIG. 1, network 110 comprises access point 130a and one or more wireless stations including wireless station 140a. Further, network 112 comprises access point 130b and one or more wireless stations including wireless station 140b and wireless station 140c. Assuming that, access point 130a and 130b are connected to controller 150; that access point 140c is connected to controller 155; and, that controller 150 and controller 155 are connected through one or more management network devices including a network router (not shown). Thus, according to the scenario assumed above, controller 150, access point 130a, and access point 130b will be in the same sub-network or VLAN. Moreover, controller 155 and access point 130c will be in another sub-network or VLAN. Hence, by default, clients connected to network 110 or 112, e.g., client 140a or client 140b, will be assigned an IP address within the same sub-network after initial association, and clients connected to network 118, e.g., client 140c, will be assigned an IP address within a different sub-network.

In some embodiments, network controllers (e.g., controller 150 and controller 155) are designated as the first level key holders, which maintain the first level security keys for clients in a multi-layer key hierarchy; and, access points are designated as the second level key holder in the key hierarchy in roaming domain 100.

During operations, wireless stations, such as wireless stations 140a, 140b, 140c, etc., are associated with their corresponding access points 130a, 130b, 130c, etc. Each wireless station may roam to associate with another access point in the roaming domain. Note that although only one roaming domain is depicted in FIG. 1, two or more roaming domains may be included in the system without departing from the spirits of the present disclosure. Thus, the new access point that the wireless station will be associated with may be located within the same roaming domain or within a different roaming domain from the roaming domain corresponding to the access point that the wireless station is currently associated with.

Note that a roaming domain generally includes a collection of network entities that can discover, share, or extend a wireless client's network connectivity state. Specifically, the roaming domain may include, but is not limited to, a mobility domain in accordance with IEEE 802.11r standard, which includes a set of wireless network devices that defines the realm of seamless roaming for wireless clients.

Moreover, a home agent is identified for each wireless client. In accordance to IEEE 802.11r standard, when a wireless client initiates a fast BSS transition to another access point in a different sub-network within the same mobility domain, the other access point becomes a foreign agent for the client. According to the present disclosure, the foreign agent will recognize the wireless client's home agent, and collaborate with the wireless client's home agent to ensure network layer (L3) mobility as well as data link layer (L2) for the wireless client.

### Hierarchical Security Key Management Scheme

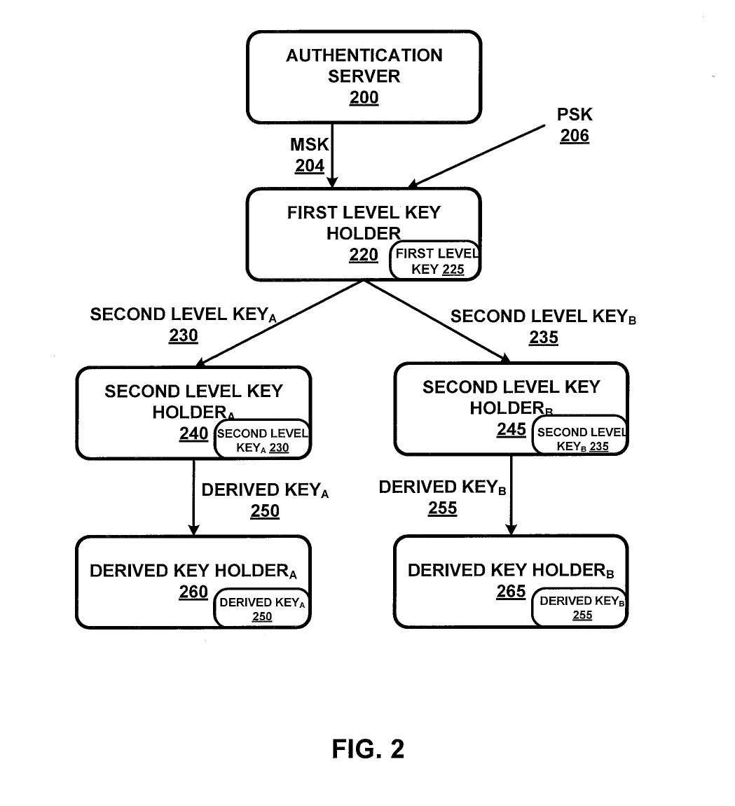

FIG. 2 illustrates an exemplary hierarchical security key management scheme used in fast BSS transition. The hierarchical security key management scheme consists of multiple levels. Each security key holder may be a part of either an access point key management (authenticator key holders) or a station key management (supplicant key holders). In the exemplary three-level security key management scheme depicted in FIG. 2, the fast BSS transition key holder architecture includes at least the first level pairwise master keys (PMK-R0), the second level pairwise master keys (PMK-R1), and the derived security keys (pairwise transient key, PTK).

Moreover, the functions of IEEE 802.1X authenticator are distributed among the first level security key holder 220 (e.g., ROKH for authenticator) and the second level security key holders 240 (e.g., R1KH for authenticator) in each network that is associated with a unique BSSID. The first level security key holder 220 interacts with the IEEE 802.1X authenticator 200 to receive MSK 204 or PSK 206, which results from an Extensible Authentication Protocol (EAP) authentication. The second level security key holder 240 interacts with the IEEE 802.1X authenticator 200 to open a controlled port. IEEE 802.1X standard defines two logical port entities for an authenticated port—the “controlled port” and the “uncontrolled port.” The controlled port is manipulated by the 802.1X Port Access Entity (PAE) to allow or prevent network traffic ingressing to or egressing from the controlled port based on the authorization state. On the other hand, the uncontrolled port is used by the PAE to transmit and receive EAP over LANs (EAPOL) frames.

First level key holder 220 (e.g., R0KH in IEEE 802.11r) stores the first level keys (e.g., PMK-R0 in IEEE 802.11r) for the wireless devices in the network. In some embodiments, a single first level key holder 220 is designated for every wireless client in the same mobility domain. According to some embodiments, first level key 225 (e.g., PMK-R0 in IEEE 802.11r) is unique to each wireless client and remains the same for the wireless client as long as the wireless client is associated with the same mobility domain. In some embodiments, first level key 225 is derived from a master session key (MSK) 204 which is received from authentication server 200 or from a pre-shared key (PSK) 206 which is pre-established between the wireless client and the wireless network.

Authentication server 200 can typically be a Remote Authentication Dial-In User Service (RADIUS) server and any other network servers capable of processing Authentication, Authorization, and Accounting (AAA) transactions. MSK 204 is formed at the supplicant and authentication server 200 during an initial association phase, such as the Initial Mobility Domain Association (IMDA) to the authenticator. Moreover, PSK 206 is pre-established between the wireless client and the wireless network.

MSK 204 or PSK 206 is used to derive the first level pairwise master key (e.g., first level key 225 or PMK-R0 under IEEE 802.11r) on both the supplicant and authenticator. Whether MSK 204 or PSK 206 is used to derive first level key 225 is based on the Authentication and Key Management (AKM) suite negotiated by a second level key holder 240 or 245. For example, in some embodiments, if the negotiated AKM is 00-0F-AC:3, then MSK 204 will be used to derive first level key 225 (e.g., PMK-R0); if the negotiated AKM is 00-0F-AC:4, then PSK will be used to derive first level key 225.

Moreover, besides the aforementioned basis for security key derivation, first level security key 225 (e.g., PMK-R0) can also be derived from one or more of the following information:
Service set identifier (SSID);
Length of SSID;
Mobility domain identifier (MDID);
Unique identifier associated with the first level key holder for authenticator (R0KH-ID, e.g., the network controller's MAC address);
Length of unique identifier associated with the first level key holder for authenticator (R0KH-ID);
Unique identifier associated with first level key holder for supplicant (S0KH-ID, e.g., the supplicant's MAC address); and
a string token input used to derive the first level security key (e.g., “FT-R0” under IEEE 802.11r standard).

In some embodiments, the input used to derive the first level security key can be a fixed string input to a one-way hash function, such as a KDF-384 hash function. For example R0-Key-Data may be a hash result that is produced by a hash function performed on any combination of inputs such as XXKey, “FT-R0”, SSIDlength, SSID, MDID, R0KH-ID, S0KH-ID, etc. More specifically, the first level security key data (which can be used to directly derive the first level security key) can be calculated according to the following formula:

R0-Key-Data=KDF-384 (XXKey, “FT-R0”, SSIDlength∥SSID∥MDID∥R0KH-ID∥S0KH-ID)

In some embodiments, from the first level PMK (e.g., PMK-R0), a set of unique second level PMKs (e.g., PMK-R1s) is derived on the supplicant and the authenticator, where each second level PMK (e.g., PMK-R1 under IEEE 802.11r) corresponds to a second level key holder (such as an access point) in the network. The first level key holder (e.g., R0KH under IEEE 802.11r) then distributes, through a mutually-authenticated and confidential connection, each second level PMK (e.g., PMK-R1) to its corresponding second level key holder (e.g., R1KH). In some embodiments, the second level PMK is derived by the first level security key holder for the authenticator (e.g., R0KH) in conjunction with the first level security key holder for the supplicant (e.g., S0KH).

First level key holder 220 derives a second level security key for each second level key holder and client. Specifically, in the example illustrated in FIG. 2, second level key_{A} 230 is derived for a specific client by first level key holder 220 and distributed to second level key holder_{A} 240 from first level key holder 220; and second level key_{B} 235, which is different from second level key_{A} 230, is derived for the same client by first level key holder 220 and distributed to second level key holder_{B} 245 from first level key holder 220. Second level key_{A} 230 and second level key_{B} 235 can be derived based on one or more of the following information:
First level key 225;
Unique identifier associated with second level key holder for authenticator (R1KH-ID, e.g., the BSSID associated with the access point);
Unique identifier associated with second level key holder for supplicant (S1 KH-ID, e.g., the supplicant's MAC address); and
a string token input used to derive the second level security key (e.g., “FT-R1” under IEEE 802.11r standard).

In some embodiments, the input used to derive the second level security key can be a fixed string input to a one-way hash function, such as a KDF-256 hash function. For example, PMK-R1 may be a hash result that is produced by a hash function performed on any combination of inputs such as PMK-R0, “FT-R1”, R1KH-ID, S1 KH-ID, etc. More specifically, the second level security key can be calculated according to the following formula:

PMK-R1=KDF-256 (PMK-R0, “FT-R1”, R1KH-ID∥S1KH-ID)

Hence, first level key holder 220 stores first level key 225. Second level key holder_{A} 240 stores second level key_{A} 230; and second level key holder_{B} 245 stores second level key_{B} 235, respectively. In some embodiments, a secure channel is established between first level key holder 220 and each second level key holder 240 or 245 to directly exchange cryptographic keys without being exposed to any intermediate parties. The cryptographic strength of the secure channel is greater than or equal to the strength of the secure channels for which the exchanged cryptographic keys will be used.

Although only one first level key holder 220 is depicted in FIG. 2, it shall be noted that authentication server may provide MSK 204 (or PSK 206 may be configured on) to two or more first level key holders 220 in different mobility domains. Moreover, although two second level key holders are depicted in FIG. 2, a mobility domain may include more than two second level key holders, such as second level key holder_{A} 240 or second level key holder_{B} 245, or only one second level key holder.

In addition, second level key holders for authenticator and supplicant derive the derived keys (such as derived key_{A} 250 and derived key_{B} 255) in conjunction with each other. In some embodiments, derived keys are the third level keys in a fast BSS transition (FT) key hierarchy. In one embodiment, the derived keys are pairwise transient keys (PTKs). In some embodiments, the derived keys can be derived from one or more of the following information:
Second level key, such as second level key_{A} 230 or second level key_{B} 235;
A random number generated by an authenticator (e.g., ANonce);
A random number generated by a supplicant (e.g., SNonce);
A unique network identifier (e.g., the BSSID associated with the access point);
A unique client identifier (e.g., the wireless client station's MAC address); and
a string token input used to derive the derived security key (e.g., “FT-PTK” under IEEE 802.11r standard).

In some embodiments, the input used to derive the derived security key can be a fixed string input to a one-way hash function, such as a SHA256-based pseudo-random hash function (e.g., KDF-PTKLen hash function). For example, PTK may be a hash result that is produced by a hash function performed on any combination of inputs such as PMK-R1, “FT-PTK”, SNonce, ANonce, BSSID, Station address (STA-ADDR), etc. More specifically, the derived security can be calculated according to the following formula:

PTK=KDF-PTKLen(PMK-R1, “FT-PTK”, SNonce∥ANonce∥BSSID∥STA-ADDR).

### Fast Basic Service Set (BSS) Transition (FT) Mechanism

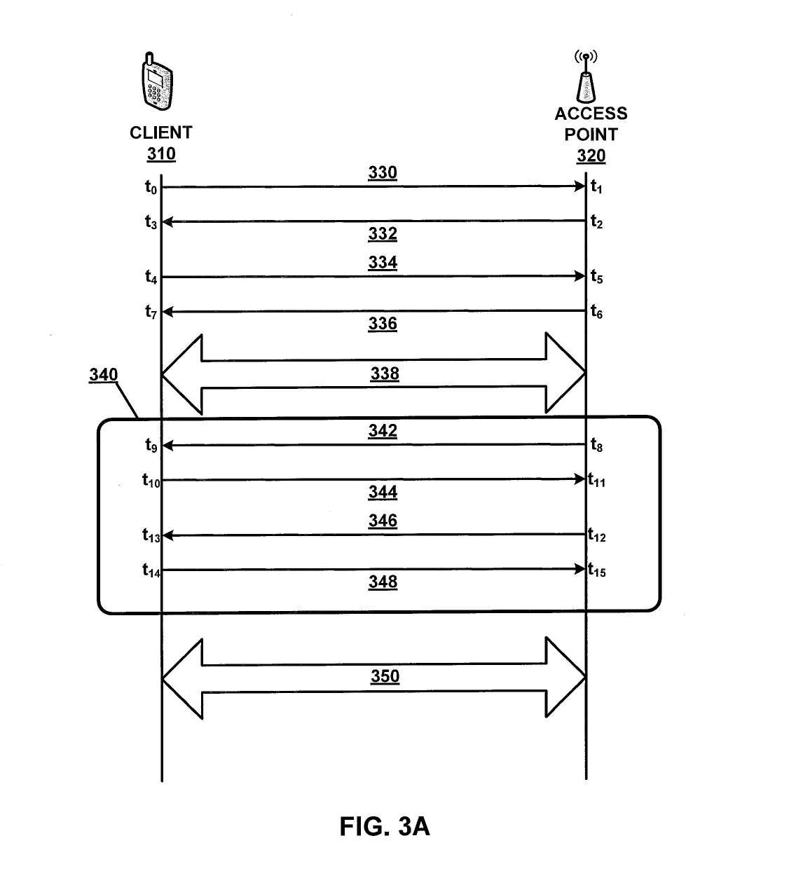

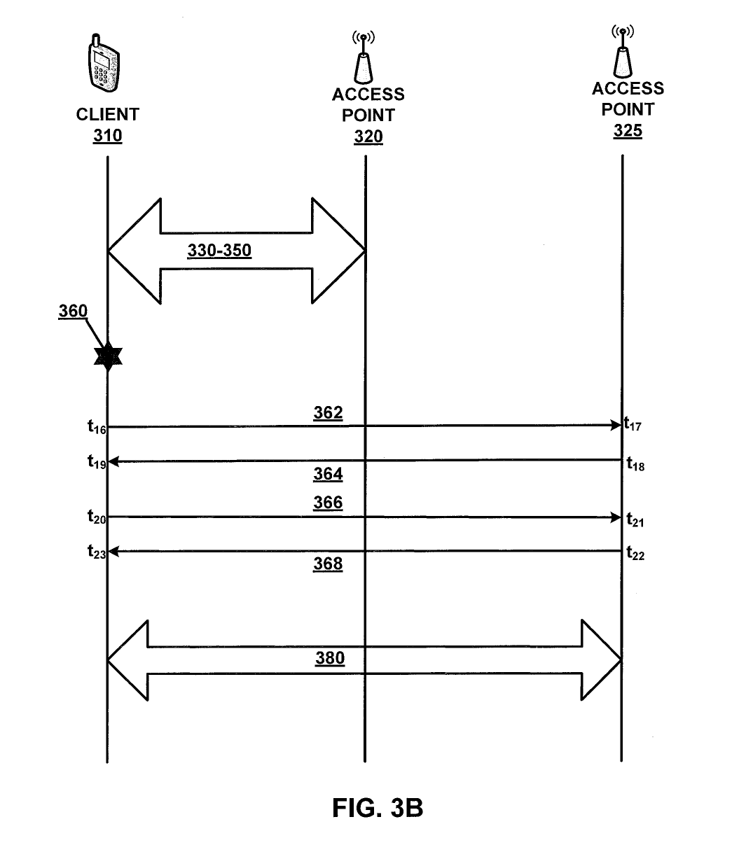

FIGS. 3A-3B illustrate exemplary communications exchanges during fast BSS transition. In a basic FT process, when a wireless station moves into the coverage of a mobility domain for the very first time, the wireless station will start interacting with the wireless network device (such as an access point), which is located in the closest proximity to the station. The wireless station will follow through an FT initial mobility domain association with the nearest access point. Thereafter, when the wireless station roams to a different access point, the wireless station will follow through an FT (re)association procedure with the new access point to reduce the overhead handoff time and improve data connectivity.

A. FT Initial Mobility Domain Association

FIG. 3A illustrates the FT initial mobility domain association (IMDA), which occurs when a wireless station associates with a nearest access point in a mobility domain for the first time without any prior association with any other access points in the same mobility domain. In the FT IMDA, the following frames and/or information will be exchanged:
management frames to complete the authentication process;
management frames to complete the association process;
authentication exchanges, such as IEEE 802.1X EAP authentication (note that this is bypassed if PSK is used); and/or
key exchanges, such as an EAPOL-Key handshake for key exchange.

Specifically, in the exemplary communication exchanges between client 310 and access point 320 in FIG. 3A, client 310 first initiates the FT IMDA by transmitting authentication request 330, such as an IEEE 802.11 authentication request, to the access point at time point t₀. After access point 320 receives an authentication request 330, e.g., an IEEE 802.11 Authentication request, at time point t₁, access point 320 sends authentication response 332, e.g., an IEEE 802.11 Authentication response, back to client 310 at time point t₂. In some embodiments, authentication request 330 and authentication response 332 both use Open System authentication mechanism in accordance with the IEEE 802.11r standard.

Next, upon successful authentication at time point t₃, client 310 will send association request 334, e.g., an IEEE 802.11 Association Request, to access point 320 at time point t₄. According to some embodiments, association request 334 may include a Mobility Domain Information Element (MDIE) and a Robust Security Network Information Element (RSNIE) as specified in IEEE 802.11 standards. MDIE is included in association request 334 to indicate client 310's support for the FT procedures, whereas RSNIE is included in association request 334 to indicate client 310's security capabilities. Access point 320 can advertise the content of MDIE in its beacon or probe response frames.

Once association request 334 is received at access point 320 at time point t₅, access point 320 will send association response 336, e.g., an IEEE 802.11 Association Response, at time point t₀; and association response 336 is received by client 310 at time point t₇. Note that, if the contents of MDIE do not match the contents advertised, or if the contents of RSNIE do not indicate a negotiated AKM suite of FT (such as, suite type 00-0F-AC:3 or 00-0F-AC:4), access point 320 will reject association request 334. In some embodiments, association response 336 may include a Mobility Domain Information Element (MDIE) with contents as presented in beacon and/or probe response frames, and a Fast BSS Transition Information Element (FTIE), as specified in IEEE 802.11. The FTIE may include, for example, a unique identifier associated with the first level key holder (e.g., R0KH-ID under IEEE 802.11r) and/or a unique identifier associated with the second level key holder (e.g., R1KH-ID under IEEE 802.11r).

Upon successful association between client 310 and access point 320, the supplicant's first level key holder (e.g., S0KH) on client 310 and the authenticator's first level key holder (e.g., R0KH) on access point 320 or a network controller coupled to access point 320 will proceed to perform an authentication procedure 338 involving multiple communication exchanges in accordance with, e.g., IEEE 802.1X EAP authentication. Upon successful completion of authentication procedures 338 (e.g., IEEE 802.1X EAP authentication), the authenticator's first level key holder (R0KH) receives MSK and corresponding authorization attributes. If a key hierarchy already exists for client 320, the authenticator's first level key holder (R0KH) will delete existing first level and second level security keys, and re-calculate a new first level security key and a second level security key for client 310 using the received MSK. However, if PSK is used, the IEEE 802.1X EAP authentication procedure can be bypassed.

Next, the second level key holders for the supplicant and the authenticator perform an FT 4-way handshake 340. Specifically, at time point t₈, access point 320 (authenticator's second level key holder, R1KH) sends a first message 342, such as an EAPOL-Key frame including a random number generated by the authenticator (e.g., ANonce), to client 310 (supplicant's second level key holder, S1 KH). Client 310 receives the first message 342 at time point t₉, and sends a second message 344 to access point 320 at time point t₁₀. The second message 344 can be an EAPOL-Key frame. In one embodiment, the EAPOL-Key frame of the second message 342 includes a random number generated by the supplicant (e.g., SNonce), and RSNIE which indicates the name of the second level security key (e.g., PMK-R1) calculated by the supplicant's second level key holder (S1KH) based on a pre-agreed-upon procedure. Thereafter, at time point t₁₁, access point 320 receives the second message 344 and sends a third message 346 to client 310 at time point t₁₂. In one embodiment, the third message 346 is an EAPOL-Key frame, which includes ANonce and the name of the second level security key (e.g., PMK-R1). This name in the third message 346 should be the same as the one received in the second message 344. After client 310 receives the third message 346 at time point t₁₃, client 310 sends a fourth message 348 back to access point 320 at time point t₁₄, and access point 320 receives the fourth message 348 at time point t₁₅. Note that the RSNIE fields, as well as the FTIE and MDIE, in the EAPOL-Key frames used in the 4-way handshake 340 shall be consistent among the first message 342, the second message 344, the third message 346, and the fourth message 348.

Finally, upon completion of the 4-way handshake 340, derived keys (e.g., PTKs) will be calculated for each specific <second level key holder, client> pair. Also, the IEEE 802.1X controlled port will be opened on both client 310 and access point 320. All subsequent communication exchanges 350 involving data transmissions between client 310 and access point 320 shall be protected by the derived key.

B. FT Roaming within Mobility Domain

FIG. 3B illustrates exemplary communication exchanges during an FT roaming by client 310 from one access point 320 to another access point 325, which is located within the same mobility domain. In this example, client 310 has followed through communication exchanges 330-350, as described above in reference to FIG. 3A, with access point 350. Then, client 310 roams to a new location and decides 360 to initiate FT to another network device, such as access point 325.

In the communication exchanges between client 310 and access point 325, the following frames are exchanged in the following time sequence:
An authentication request 362, which is sent by client 310 at time point t₁₆ and received by access point 325 at time point t₁₇.
An authentication response 364, which is sent by access point 325 at time point t₁₈ and which is received by client 310 at time point t₁₉;
A re-association request 366, which is sent by client 310 at time point t₂₀ and received by access point 325 at time point t₂₁; and
A re-association response 368, which is sent by access point 325 at time point t₂₂ and received by client 310 at time point t₂₃.

The exchange of information through these communication exchanges between client 310 and access point 325 completes the association between client 310 and access point 325, and also completes the derivation of the derived key (e.g., PTK). Thereafter, all subsequent communication exchanges 380 involving data transmissions between client 310 and access point 325, shall be protected by the derived key.

### Data Link Layer and Network Layer Mobility Using Leveled Security Keys

In order to provide data link layer and network layer mobility, the new network device or access point that a wireless client roams to, stores various information related to the wireless client's home agent, and collaborates with the wireless client's home agent to provide the wireless client with multi-layer mobility, including, e.g., network layer (L3) mobility and data link layer (L2) mobility.

In some embodiments, a client is initially associated with a first access point (e.g., a home agent or HA) coupled to a first controller in a first sub-network. Then, the client initiates a fast BSS transition to associate with a second access point (e.g., a foreign agent or FA) coupled to a second controller in a second sub-network. In such embodiments, if the client is to be assigned a new IP address, it will likely impact the client's use of some applications on the device, such as VoIP applications, video streaming applications, etc.

In other embodiments, static IP addresses may be configured on mobile client devices. Thus, the mobile client devices need to retain connectivity to the network when they move to a different sub network within the network, where it would not be possible to service them using their existing IP address.

Hence, in these embodiments, it would be desirable to allow the client to maintain the same IP address in the second sub-network. In order to do so, the management network devices (e.g., access points, network controllers, etc.) need to communicate with each other to coordinate the routing of the packets destined to or originated from the client roamed to the foreign network. Specifically, to support clients in the above embodiments, and to leverage roaming domain (such as mobility domain in accordance with IEEE 802.11r) to provide data link layer and network layer mobility within the network, the following requirements need to be met:

(1) A home agent (“HA”) should be assigned for every mobile client device that associates to the network. The HA is typically a network device that acts as a first level key holder (e.g., R0KH in accordance with IEEE 802.11r standard) for the mobile client device when the mobile client device associates to the roaming domain for a first time. All other first level key holders (e.g., APs and controllers) within the same roaming domain will then become Foreign Agents (“FA”) for this mobile client device. Hence, for every mobile wireless client device, there will be exactly one HA, but there could be multiple FAs within a same roaming domain.

(2) An HA should be identified for any mobile client device that roams to a different part of the network. This facilitates the network to identify whether a mobile client device is a “visitor” or a “first timer” to the network. When a wireless client device that was previously associated with the network moves to a different sub network within the roaming domain, the wireless client device may receive service from a network device which has a different first-level key holder (e.g., R0KH in accordance with IEEE 802.11r standard). In such a case, the wireless client device will be identified as a “visitor” because its home agent is different from the first level key holder of the current sub network. Moreover, the first level key holder in this sub network will act as a foreign agent (“FA”) for the wireless client device. The FA would be responsible for setting up the tunnels and routing entries such that the wireless client device does not suffer a loss of connectivity while retaining its IP address.

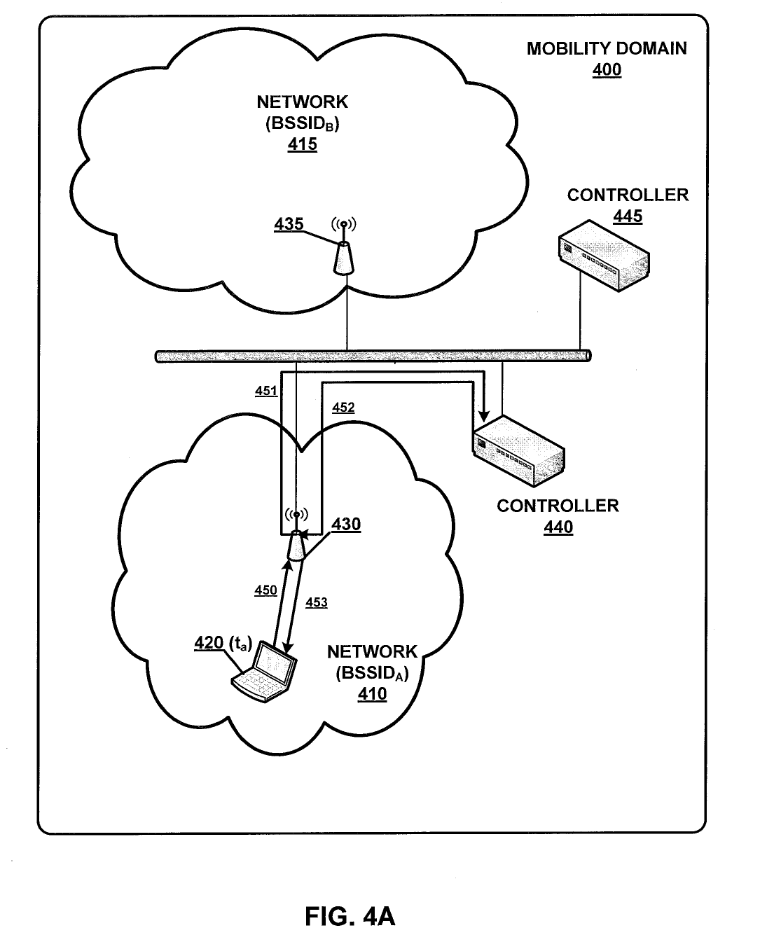

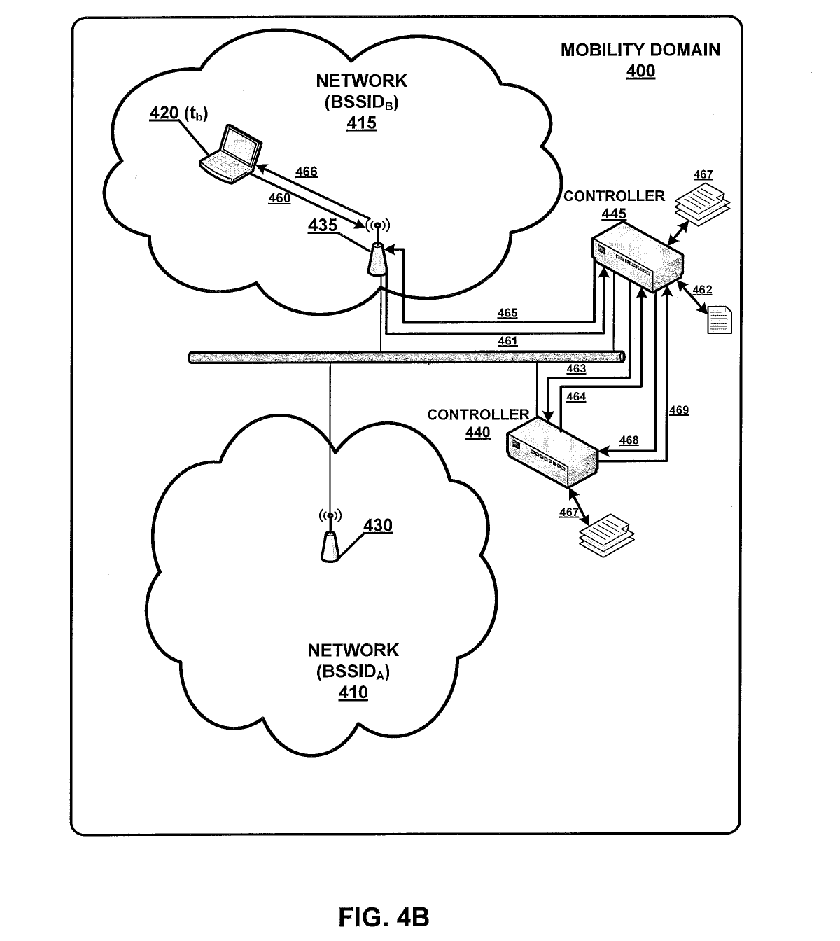

FIGS. 4A-4B describes an exemplary communication process among various network devices in order to provide a client with both data link layer (L2) mobility and network layer (L3) mobility.

A. Communications with Home Agent Prior to Fast BSS Transition

FIG. 4A shows exemplary communications with a home agent prior to a client (e.g., a client supporting IEEE 802.11r standards) initiating a fast BSS transition. FIG. 4A describes a mobility domain 400 that includes multiple networks, e.g., network 410 identified by BSSID_{A} and network 415 identified by BSSID_{B}. Each network, such as network 410 (or network 415), may further include one controller and one or more access points. For example, network 410 includes access point 430 and network 415 includes access point 435. Moreover, one or more clients can be associated with each access point in either network.

In the illustrated example, multiple wireless network devices (e.g., controller 440 and controller 445) can be a part of a single mobility domain in compliance with IEEE 802.11r standards. When a client 420 enters a corporate network initially at time tₐ, client 420 transmits an association request 450 to one of the wireless network devices (e.g., access point 430). Subsequently, after completion of the FT IMDA, client 420 is assigned an IP address corresponding to network 410. Thus, client 420 can proceed to send and receive data using the assigned IP address as its unique identifier identifying client 420 in the corporate network.

After access point 430 receives from client 420 association request 450, which is an initial mobility domain association request, access point 430 sends message 451 to controller 440 in the same network. In some embodiments, message 451 includes client 420's identifying information, e.g., MAC address, to facilitate controller 440 derive security keys for client 420.

In some embodiment, controller 440 obtains a MSK from an authentication server or obtains a PSK, and uses the obtained key to derive a first level security key (e.g., R0KH) and a second level security key (e.g., R1KH). In some embodiments, controller 440 also generates a first level security key holder identifier (e.g., R0KH ID) and optionally a second level security key holder identifier (e.g., R1KH ID). The unique first level and second level key holder identifiers, along with the MSK or the PSK, allow the recipient of the key holder identifiers to derive the corresponding leveled security keys. In some embodiments, controller 440 sends the second level security key holder identifier (R1KH ID) in message 452. In other embodiments, controller 440 may send to access point 430 the first level security key (e.g., R0KH) directly in message 452, for example, through a secured tunnel. If access point 430 receives the second level security key holder identifier, it will use that information to derive the second level security key (e.g., R1KH). Thus, the second level security key (e.g., PMK-R1) can be either derived at access point 430 independently or received from controller 440.

According to embodiments of the present disclosure, the wireless network device to which the client gets associated when it enters the corporate network for the first time becomes its Home Agent (“HA”). Thus, in the example illustrated in FIG. 4A, access point 430 (or controller 440) will become the HA for client 420 when client 420 associates with access point 430 at time tₐ. The Home Agent normally is responsible for routing all packets to and from client 420. In some embodiments, the first level key holder can be the same as the second level key holder in network 410. Hence, the HA will be the device acting as both the first level key holder and the second level key holder.

Note that, after initial mobility domain association (IMDA) with the Home Agent, the client is assigned an IP address within the same sub network as the HA, and uses the assigned IP address to identify itself in the network. In some embodiments, this IP address might be configured as a static IP address on the client.

B. Leveraging Roaming Domain to Achieve L2/L3 Mobility

FIG. 4B shows exemplary communications which leverage a roaming domain (e.g., a mobility domain in accordance with IEEE 802.11r standard) to achieve data link layer and network layer mobility. The communications involve at least a foreign agent after a client (e.g., a client supporting IEEE 802.11r standards) initiates a fast BSS transition (“FT”). Specifically, during operations, the client may move to a different part of the network where it needs to be associated with a different wireless network device (e.g., access point). To do so, the client may initiate an FT request, and the network may use a mechanism that identifies the client's HA and allows the client to maintain its existing IP address.

FIG. 4B includes a mobility domain 400 which includes multiple networks, e.g., network 410 as identified by BSSID_{A} and network 415 as identified by BSSID_{B}. Each network, such as network 410 (or network 415), may further include one controller and one or more access points. For example, network 410 includes access point 430 and network 415 includes access point 435. Moreover, one or more clients can be associated with each access point in either network. In this example, each network device (e.g., controller) may store routing table 467 and refer to routing table 467 to determine how to route a packet destined to or originated from roaming client 420. Furthermore, each network device (e.g., controller) may also maintain record 462, which keeps track of the first level key holder identifiers and their corresponding IP addresses in mobility domain 400.

In some embodiments, leveled security keys can be used in place of Mobile IP protocol to provide the mobility functionalities to the client. In the example illustrated in FIG. 4B, it is assumed that client 420 supports the IEEE 802.11r standards. In addition, wireless network devices (e.g., controller 440 and controller 445) which are a part of the same mobility domain 400, form a part of the L2/L3 mobility domain. Hence, when client 420 initiates a fast BSS transition, for example, from {network 410, AP 430, Controller 440} to {network 415, AP 435, Controller 445} at time t_{b}, client 420 will maintain its existing IP address, which was assigned to client 420 while associated with AP 430.

Specifically, wireless network device (e.g., controller 445) in network 415 needs to be able to identify the Home Agent of client 420 when client 420 associates with AP 435 that is coupled to controller 445. As defined previously in section above, the Home Agent (HA) for client 420 is a wireless network device (e.g., AP 430 or controller 440) from which the client receives the first level security key holder identifier when it enters a mobility domain in accordance with IEEE 802.11r standards for the very first time. Once the HA for client 420 is identified, all other wireless network devices (e.g., AP 435, or controller 445, etc.) present in the same IEEE 802.11r mobility domain and capable of functioning as first level security key holders, will then become the Foreign Agents (FA) for client 420. Hence, for each client, there will be only one HA, but one or more FAs in an IEEE 802.11r mobility domain.

Furthermore, a tunnel will be created between the FA and the HA. In some embodiments, both the FA and the HA will also add routing entries in their routing tables accordingly so that the packets destined to or originated from the wireless client device can be routed over the tunnel. Therefore, the wireless client device will retain its IP address and identity in the network, even if there is a change in its point of attachment to the network. In some embodiments, it is also possible that the tunnel is used only for one-way transmission of packets from the HA to the FA, such that only those packets that are destined to the wireless client device are transmitted over the tunnel. On the other hand, those packets originating from the wireless client device, the FA would rely on its routing logic to route those packets to the destination.

Moreover, it shall be noted that there would a tunnel between each network device that acts as (or is capable of acting as) a first level key holder within the same IEEE 802.11r mobility domain. Such tunnels may also be created apriori. For example, tunnels between controller 440 and controller 445 in a single mobility domain 400 can be set up at the time when controller 440 and controller 445 are configured, or be set up at a later time.

Thereafter, when client 420 moves to a different sub network (e.g., network 415) within mobility domain 400, client 420 will receive service from a different network device (e.g., AP 435). The servicing network device (e.g., AP 435 or controller 445) will become the Foreign Agent (FA) for client 420. In an IEEE 802.11r mobility domain, such as mobility domain 400, information about client 420's HA can be available to FA during a re-association phase of client 420.

More specifically, at time t_{b}, client 420 initiates a fast BSS transition by sending an FT request 460 to AP 435 in network 415. In some embodiments, the FT request 460 may be an IEEE 802.11 Authentication Request with Authentication Algorithm set to a value of 2 to indicate that this is a request for a Fast-BSS Transition (FT). FT request 460 may include at least a first level security key holder identifier (e.g., R0KH ID in accordance with IEEE 802.11r standard). Subsequently, controller 445 acting as the foreign agent will need to receive the first level security key (e.g., PMK-R0) from controller 440 acting as the home agent for the client. Specifically, in some embodiments, the first level security key may proactively be transmitted from the home agent to all the foreign agents in the mobility domain. In such a case, secure tunnels would be established between all network devices that are capable of acting as the first level security key holders in the IEEE 802.11r Mobility Domain (e.g., all controllers and/or APs that can act as Home Agents and/or Foreign Agents). In some embodiments, the secured tunnels would be established when such network devices become active for the first time. In other embodiments, the secured tunnels would be established when a new network device that is capable of acting as a first level key holder is discovered in the network. After a wireless client successfully completes the initial association with a mobility domain, e.g., the Initial Mobility Domain Association in accordance with the IEEE 802.11r standard, the first level key security key (e.g., PMK-R0) corresponding to the security association between the wireless client and the Home Agent of the wireless client will be sent over the secure tunnels to all the Foreign Agents for this wireless client in the Mobility Domain.

In other embodiments, the foreign agent may query for the first level security key upon receiving an FT request from the client. For example, after AP 435 receives FT request 460, AP 435 extracts the first level security key holder identifier (e.g., R0KH ID in accordance with IEEE 802.11r standard) from FT request 460, and forwards the first level security key holder identifier (e.g., R0KH ID in accordance with IEEE 802.11r standard) to controller 445 in message 461.

Also, controller 445 looks up record 462, and retrieves the controller identifier corresponding to the received first level security key holder identifier. Assuming that controller 445 retrieves controller 440's identifier in the illustrated example, controller 445 will then send a message comprising of the received first level security key holder identifier (e.g., R0KH ID in accordance with IEEE 802.11r standard) and the MAC address of client 420 to controller 440 in request 463 to request for the corresponding first level security key for client 420 from controller 440. After controller 440 receives request 463, controller 440 responds with response message 464 which includes the requested first level security key (e.g., PMK-R0). After controller 445 receives the first level security key (e.g., PMK-R0) from controller 440, controller 445 can use the received first level security key and a unique identifier corresponding to AP 435 to derive a second level security key (e.g., PMK-R1_{B}). The unique identifier is the second level key holder identifier corresponding to AP 435. Subsequently, controller 445 can send either the derived second level security key (e.g., PMK-R1_{B}) or the received first level security key (e.g., PMK-R0) to AP 435 in message 465. If the first level security key (e.g., PMK-R0) is sent to AP 435, AP 435 will independently derive its second level security key (e.g., PMK-R1_{B}).

On the other hand, if controller 440 indicates in response message 464 that there is no first level security key corresponding to security association between client 420 and the first level security key holder identifier supplied by controller 445 in message 463, then controller 445 will instruct AP 435 to de-authenticate client 420 in message 465. This is done so that the client 420 may initiate a fresh Initial Mobility Domain Association in the current sub-network.

Furthermore, after the association process between client 420 and AP 435 is completed, controller 445 may send to controller 440, message 468, which includes at least client 420's MAC address and/or IP address. Subsequently, controller 445 receives an acknowledgement message 469 from controller 440 acknowledging the receipt of client 420's MAC address and/or IP address. In some embodiments, controller 445 optionally starts a timer when sending message 468 to controller 440. If controller 445 does not receive acknowledgement message 469 from controller 440 when the timer expires, controller 445 can retransmit message 468 to controller 440.

Moreover, after controller 440 receives message 463 including the first level key holder identifier (e.g., R0KH ID), controller 440 will update its routing table 467, so that all packets received at controller 440 and destined to client 420 will be routed to controller 445 over the tunnel between the two controllers. Controller 440 may determine that a packet is destined to client 420 based on a match between the packet's destination IP address and client 420's IP address.

On the other hand, after controller 445 receives message 464 including the first level key (e.g., PMK-R0) from controller 440, controller 445 can also update its routing table 467, so that all packets received at controller 445 and originated from client 420 will be routed to controller 440. Controller 440 may determine that a packet is originated from client 420 based on a match between the packet's source IP address and client 420's IP address. In some embodiments, controller 445 need not update its routing table. Instead, it will rely on the existing routing logic to route packets originated from client 420.

Routing table 467 may include an electronic document that stores routes to various nodes in a network. The nodes may be any kind of electronic device connected to the network. Moreover, routing table can be stored in a router or any other network device in the form of a database or a file. When a packet needs to be sent from one node to another node on the network, routing table 467 will be referred to in order to find the best possible route for the packet.

Subsequently, when client 420 moves back to associate to controller 440 in its home network or when client 420 moves to a different sub network where it would receive service from a completely different first level key holder than controller 440 and controller 445, the routing entries added for client 420 in the routing tables of controller 440 and controller 445 will be removed. The network would figure out that client 420 is no longer in the domain of controller 445 in one of the following ways:
Controller 440 (Home Agent) receives a request for the first level key for client 420 from a Foreign Agent different from controller 445.
Controller 440 (Home Agent) receives message 468 which includes at least client 420's MAC address and IP address, from a Foreign Agent different from controller 445.
Controller 440 (Home Agent) receives an FT re-association request from client 420.
Controller 445 (Foreign Agent) receives a de-authentication message or a disassociation message from client 420.

C. Identification of Home Agent for Client

As described above, one important prerequisite for leveraging roaming domain (e.g., IEEE 802.11r mobility domain) to provide data link layer and network layer mobility to a wireless client device is to assign and to identify the home agent (“HA”) for the wireless client device. In the example of IEEE 802.11r mobility domain, this information is available during the re-association phase of the wireless client device. When a network device that is capable of acting as a first level key holder (e.g., controller 440 or controller 445) is added to the mobility domain, its first level key holder (e.g., R0KH ID) will be advertised within the mobility domain, such that all other first level key holders become aware of the new device that is potentially capable of acting as a home agent within the mobility domain.

There are multiple ways that the network device may advertise this identity. In some embodiments, a configuration paradigm can be used to achieve this. The configuration would be added to one controller (e.g., a master controller) and then subsequently pushed to the remaining controllers in the network.

In other embodiments, each first level key holder (e.g., R0KH) periodically broadcasts in the network layer (L3) a special packet containing the following details:
A first level key holder identifier (e.g., R0KH ID);
An IP address of the key holder; and/or
A mobility domain of the key holder.

This broadcast packet would be available to other first level key holders in the mobility domain. Therefore, the other first level key holders in the mobility domain could use the information in the broadcast packet to update their databases. In addition, each first level key holder can maintain data storage for the received first level key holder identifiers. Specifically, the data storage would include one or more of the following fields:
A first level key holder identifier (e.g., R0KH ID);
An IP address of the key holder;
A mobility domain of the key holder.
This data storage would be periodically refreshed to ensure that first level key holders that are no longer part of the network can be removed from the database.

When a wireless client device transmits the first level key holder identifier (e.g., R0KH ID) to the wireless network device during the FT process, this data storage will be used to facilitate the first level key holder to figure out the followings:
If the client's first level key holder (e.g., R0KH) is part of the same mobility domain but is different from the first level key holder in the current sub-network, then the current first level key holder acts as a foreign agent (“FA”) for the client;
If the client's first level key holder (e.g., R0KH) is not part of the same mobility domain, then the current first level key holder will act as a home agent (“HA”) for the client, for example, by ensuring that the client undergoes IMDA;
If there is no entry for the client's first level key holder (e.g., R0KH), then the current first level key holder acts as a home agent (“HA”) for the client.

Referring now to FIG. 4B, client 420 re-associates (e.g., by initiating a FT request to AP 435) with the network, controller 445 receives the first level security key holder identifier (e.g., R0KH ID) from AP 435. Next, controller 445 looks up record 462 to identify whether another controller in mobility domain 400 is the controller coupled to the home agent for client 420. Record 462 can be maintained internally at controller 445 or accessed externally from controller 445. Moreover, record 462 can be, but is not limited to, a table, a list, a tuple, a string, an object, or any other type. Record 462 identifies the first level security key holders (or first level security key holder identifiers) for the controllers in mobility domain. It can be indexed by either the key identifier or the controller identifier.

Data regarding first level security keys and controllers in mobility domain 400 can be populated to record 462 in a variety of ways. In some embodiments, each time when a new controller joins mobility domain 400, the new controller sends a Layer 3 broadcast message to the network. The broadcast message may include a first level security key holder identifier (e.g., R0KH ID), an MAC address of the new controller, and the IP address of the new controller. Typically, different controllers in the same mobility domain are located in different sub networks to improve cost-effectiveness of the network devices. Because the message sent by the new controller is a Layer 3 broadcast message, the message will be received by other controllers, even though the other controllers may belong to a different sub-network from the sub-network that the new controller belongs to. When the other controllers receive the Layer 3 broadcast message, they can store or update the first level security key holder identifier (e.g., R0KH ID), the MAC address of the controller, and the IP address of the controller in their record (e.g., record 462).

In other embodiments, one controller in a mobility domain may be elected or configured as a master controller. The master controller of the mobility domain will gather or be configured with all controller identifiers and first level security key holder identifiers in the mobility domain. Such information can be stored in a master copy of record on the master controller. Then, the master controller can send the master copy of record to the other controllers in the mobility domain, so that the other controllers can update their own copy of the record. Each time when a new controller joins the mobility domain, the master controller will add the new controller's identifier and corresponding first level security key holder identifier to the master record, and sends an update to all other controllers in the mobility domain.

### Process for Leveraging Roaming Domain to Provide L2/L3 Mobility

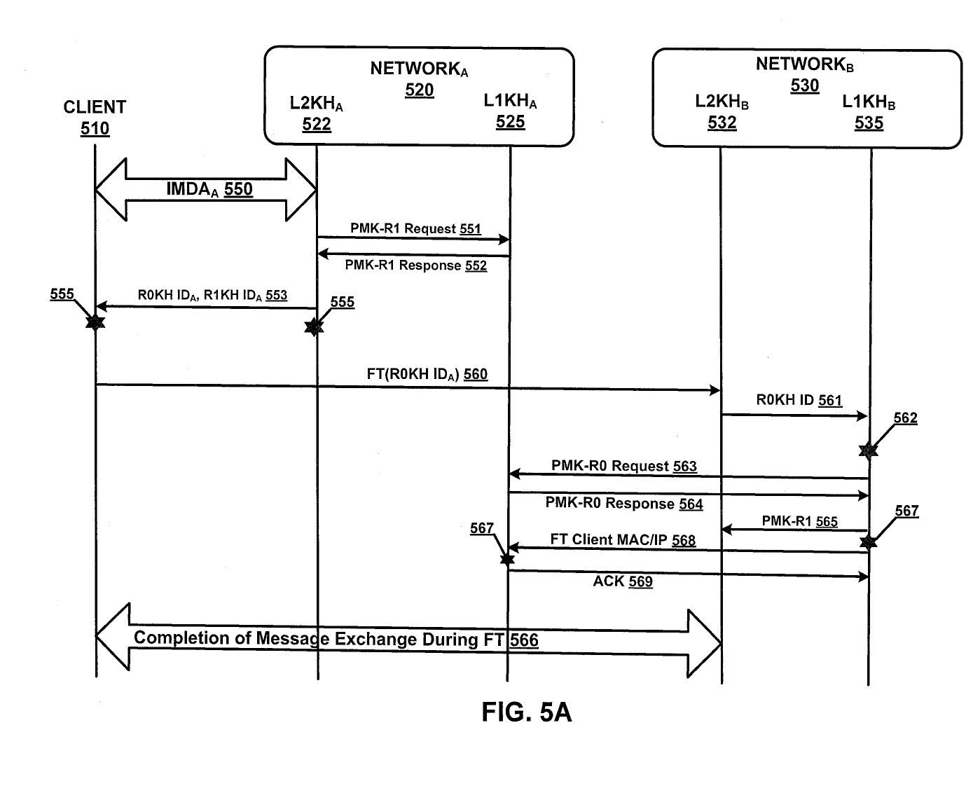

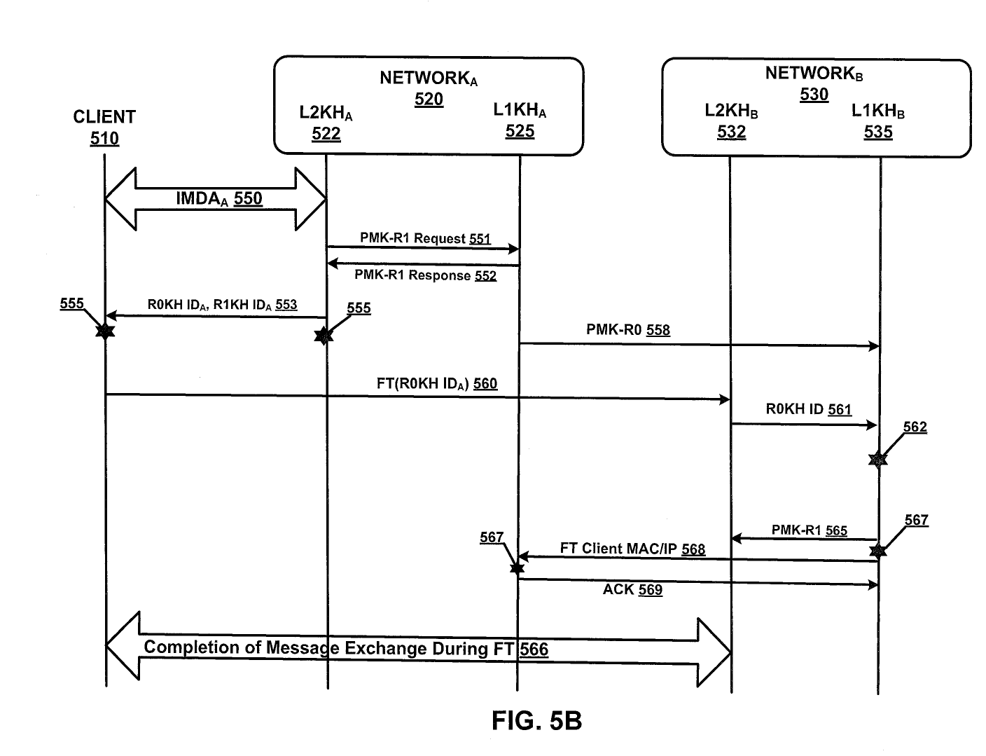

FIG. 5A-5B show sequence diagrams for leveraging roaming domain and leveled security keys to provide data link layer (L2) and network layer (L3) mobility according to embodiments of the present disclosure.

FIG. 5A includes, inter alia, client 510, network_{A} 520, network_{B} 530, etc. Also, network_{A} further includes a first level key holder L1KH_{A} 525 (e.g., R0KH_{A}) and a second level key holder L2KH_{A} 522 (e.g., R1KH_{A}); and, network_{B} further includes a first level key holder L1KH_{B} 535 (e.g., R0KH_{B}) and a second level key holder L2KH_{B} 532 (e.g., R1KH_{B}).

Initially, client 510 establishes an association with network_{A} 520 through an initial mobility domain association (IMDA_{A}) 550. After the EAP authentication is successful, L1KH_{A} 525 receives the MSK from the IEEE 802.1X Authenticator (not shown in the figure). This step is bypassed if PSK is configured for the client 510. Using this MSK (or PSK), L1KH_{A} 525 derives the first level security key for client 510 (e.g., PMK-R0) and the second level security key for client 510 (e.g., PMK-R1). L2KH_{A} 522 will send to the first level key holder L1KH_{A} 525, a request for the second level key for client 510, e.g., PMK-R1 request 551. In response, L1KH_{A} 525 sends back a response, e.g., PMK-R1 response 552, which includes the second level key for client 510. In some embodiments, L2KH_{A} 522 may send a first level security key holder identifier (e.g., R0KH ID_{A}) and a second level security key identifier (e.g., R1KH ID_{A}) (operation 553). Now, the L2KH_{A} 522 and client 510 will mutually derive the third level security key for this security association (e.g., PTK) (operation 555). Once the third level security keys have been derived and installed, the client 510 can begin to transmit and receive data.

Assuming that subsequently client 510 moves to a new location and attempts to associate with network_{B} 530, which is in a different sub network from network_{A} 520 that client 510 was previously associated with. For example, client 510 may send a FT request 560 to L2KH_{B} 532. Note that, FT request 560 includes at least a first level key holder identifier, e.g., R0KH ID_{A}, to identify the home agent for client 510. When L2KH_{B} 532 receives FT request 560, L2KH_{B} 532 retrieves the first level key holder identifier (e.g., R0KH ID_{A}) from FT request 560, and sends the first level key holder identifier, e.g., R0KH ID_{A} 561, to L1KH_{B} 535.

After receiving the first level key holder identifier (e.g., R0KH ID_{A} 561), L1KH_{B} 535 checks a record to determine whether a network device in the network corresponds to the received first level key holder identifier (operation 562). If a match is found, L1KH_{B} 535 retrieves the device identifier (e.g., an IP address of the corresponding network device). In this example, the device identifier retrieved is the IP address of L1KH_{A} 525. Next, L1KH_{B} 535 sends a request, e.g., PMK-R0 request 563, to L1KH_{A} 525 for the corresponding first level key for client 510. Subsequently, L1KH_{A} 525 returns the first level security key corresponding to client 510 in a response, e.g., PMK-R0 response 564, to L1KH_{B} 535. In some embodiments, L1KH_{B} 535 optionally searches whether the corresponding first level key has been cached, and if so, L1KH_{B} 535 may retrieve the first level key from the cache and skip the request for the first level key. In some embodiments, L1KH_{B} 535 may optionally start a timer when sending request 563 to L1KH_{A} 525. If no response is received from L1KH_{A} 525, L1KH_{B} 535 can instruct L2KH_{B} 532 to de-authenticate or disassociate with client 510. In some embodiments, if no response is received from L1KH_{A} 525, L1KH_{B} 535 can retransmit request 563 for a predetermined number of times before instructing L2KH_{B} 532 to de-authenticate or disassociate with client 510.

In some embodiments, based on the returned first level key, L1KH_{B} 535 derives a second level key that is unique to L2KH_{B} 532 and client 510. L1KH_{B} 535 sends a second level key e.g., PMK-R1 565, to second level key holder L2KH_{B} 532 in network_{B} 530. Moreover, L1KH_{B} 535 sends a message, which includes client 510's MAC address and IP address 568, to L1KH_{A} 525 to notify first level key holder L1KH_{A} 525 in network_{A} 520 that client 510 has roamed to network_{B} 530. After L1KH_{A} 525 receives message 568, L1KH_{A} 525 updates entries in its routing table (operation 567), such that all packets destined for client 510 will be routed to L1KH_{B} 535. Similarly, L1KH_{B} 535 will update entries in its routing table (operation 567), such that all packets originated from client 510 will be routed to L1KH_{A} 525. Also, L1KH_{A} 525 sends an acknowledgment message 569 back to L1KH_{B} 535.

In other embodiments, L1KH_{B} 535 sends the returned first level security key to L2KH_{B} 532. After L2KH_{B} 532 receives the first level key from L1KH_{B} 535, L2KH_{B} 532 derives the second level key based, at least in part, on the received first level key (operation 570), and proceeds to complete the message exchange during Fast-BSS Transition (operation 566) with client 510.

FIG. 5B includes, inter alia, client 510, network_{A} 520, network_{B} 530, etc. Also, network_{A} further includes a first level key holder L1KH_{A} 525 (e.g., R0KH_{A}) and a second level key holder L2KH_{A} 522 (e.g., R1KH_{A}); and, network_{B} further includes a first level key holder L1KH_{B} 535 (e.g., R0KH_{B}) and a second level key holder L2KH_{B} 532 (e.g., R1KH_{B}).

Initially, client 510 establishes an association with network_{A} 520 through an initial mobility domain association (IMDA_{A}) 550. Similar to the example illustrated in FIG. 5A, L2KH_{A} 522 will send to the first level key holder L1KH_{A} 525 a request for the second level key for client 510, e.g., PMK-R1 request 551. In response, L1KH_{A} 525 sends back a response, e.g., PMK-R1 response 552, which includes the second level key for client 510. In some embodiments, L2KH_{A} 522 may send a first level security key holder identifier (e.g., R0KH ID_{A}) and a second level security key identifier (e.g., R1KH ID_{A}) (operation 553). Subsequently, L2KH_{A} 522 and client 510 will mutually derive the third level security key for this security association (e.g., PTK) (operation 555). Once the third level security keys have been derived and installed, the client 510 can begin to transmit and receive data.

In the example illustrated in FIG. 5B, the first level security key holder L1KH_{A} 525 in network_{A} 520 may proactively transmit the first level security key PMK-R0 558 corresponding to client 510 to the first level security key holder L1KH_{B} 535 in network_{B} 530. Therefore, when client 510 moves to a new location and attempts to associate with network_{B} 530, for example, client 510 may send a FT request 560 to L2KH_{B} 532, L1KH_{B} 535 will have PMK-R0 558 cached and readily accessible. Note that, FT request 560 includes at least a first level key holder identifier, e.g., R0KH ID_{A}, to identify the home agent for client 510. When L2KH_{B} 532 receives FT request 560, L2KH_{B} 532 retrieves the first level key holder identifier (e.g., R0KH ID_{A}) from FT request 560, and sends the first level key holder identifier, e.g., R0KH ID_{A} 561 along with the MAC address of client 510, to L1KH_{B} 535.

After receiving the first level key holder identifier (e.g., R0KH ID_{A} 561) and the MAC address of client 510, L1KH_{B} 535 checks a record to determine whether a network device in the network corresponds to the received first level key holder identifier (operation 562). If a match is found, L1KH_{B} 535 will further check if there is a cached first level security key e.g., PMK-R0 558, for client 510 based on the MAC address of the client. If the first level security key, e.g., PMK-R0 558, for client 510 is present, L1KH_{B} 535 will use it to derive a second level security key, e.g., PMK-R1 565, and send the second level security key to the second level key holder L2KH_{B} 532 in network_{B} 530. In other embodiments, L1KH_{B} 535 will send the first level security key, e.g., PMK-R0 558, to L2KH_{B} 532 in network_{B} 530, thus giving L2KH_{B} 532 the information necessary to derive the second level security key for client 510.

Moreover, L1KH_{B} 535 sends a message, which includes client 510's MAC address and IP address 568, to L1KH_{A} 525 to notify first level key holder L1KH_{A} 525 in network_{A} 520 that client 510 has roamed to network_{B} 530. After L1KH_{A} 525 receives message 568, L1KH_{A} 525 updates entries in its routing table (operation 567), such that all packets destined for client 510 will be routed to L1KH_{B} 535. Similarly, L1KH_{B} 535 will update entries in its routing table (operation 567), such that all packets originated from client 510 will be routed to L1KH_{A} 525. Also, L1KH_{A} 525 sends an acknowledgment message 569 back to L1KH_{B} 535.

Once L2KH_{B} 532 has possession of the second level security key, e.g., PMK-R1 565, it proceeds to complete message exchange during the Fast-BSS Transition (operation 566) with client 510.

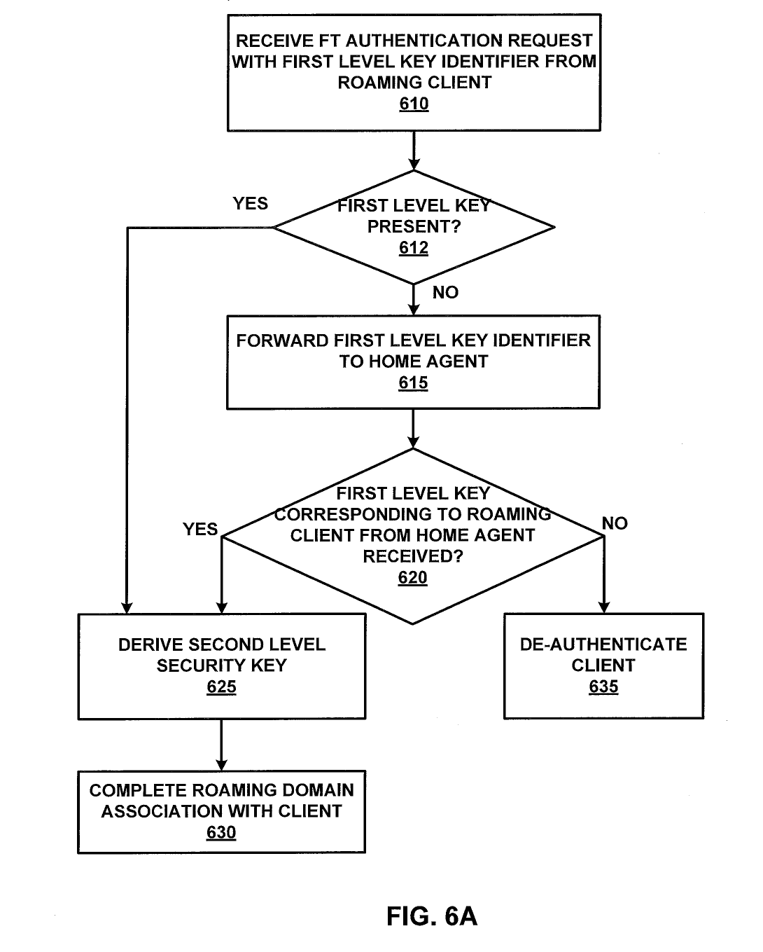

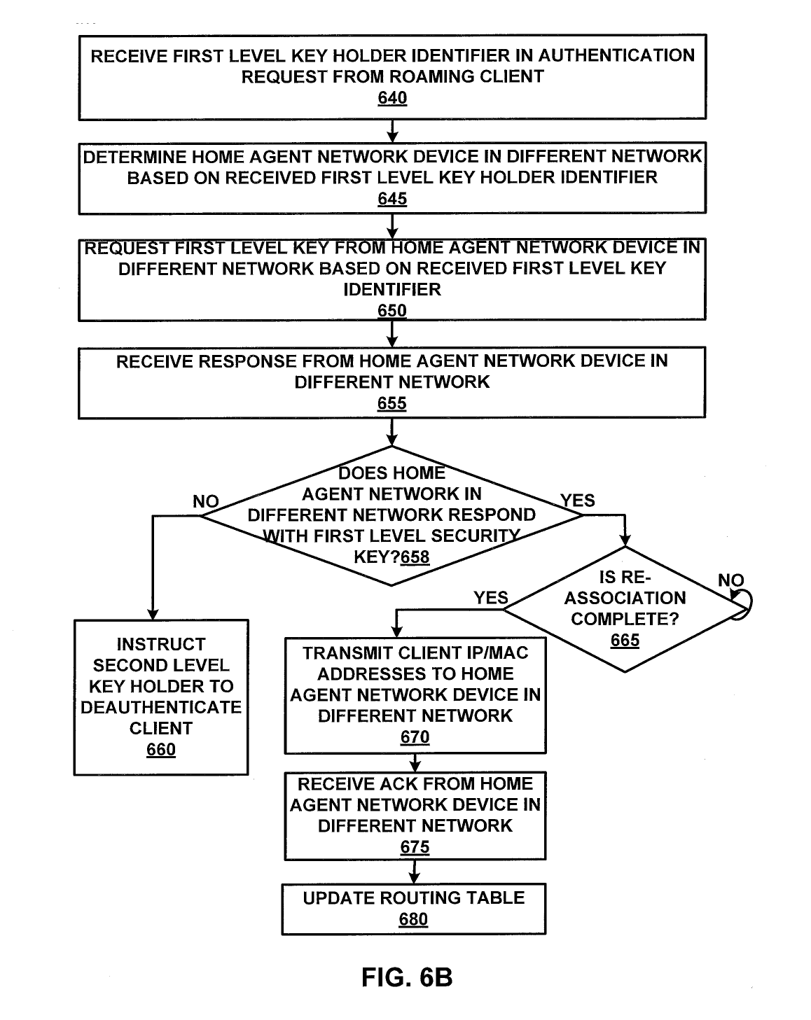

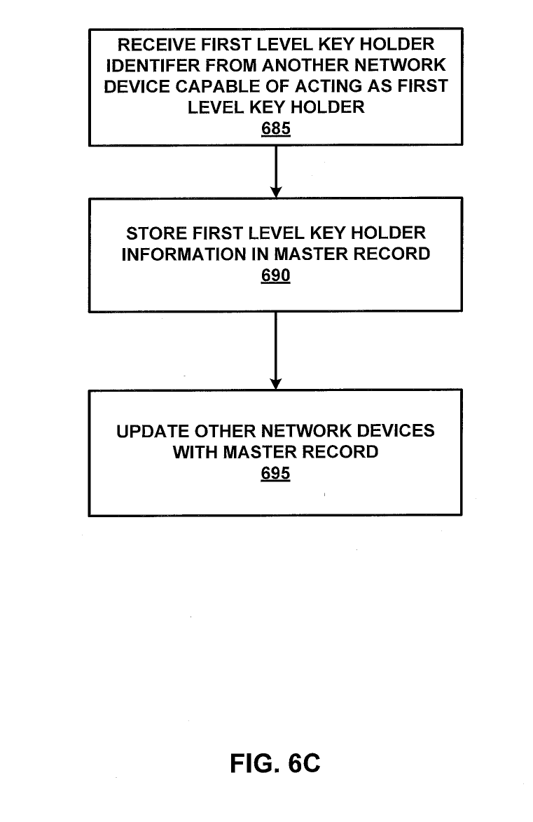

FIGS. 6A-6C are flowcharts illustrating exemplary processes for leveraging mobility domain to provide data link layer (L2) and network layer (L3) mobility according to embodiments of the present disclosure. As illustrated in FIG. 6A, during operations of a network device acting as a second level key holder in a network (e.g., network_{B}) that a client roams to, the disclosed wireless network device receives an authentication request (e.g., an Authentication request as part of the Fast-BSS Transition (FT) process in accordance with IEEE 802.11r standard), which includes a first level key identifier from the roaming client (operation 610). The wireless network device then determines whether a first level security key corresponding to the roaming client exists (operation 612).

If the first level security key does not pre-exist, the disclosed network device forwards the first level key identifier to a home agent in the network (e.g., a first level key holder in network_{B}) (operation 615). Thereafter, the wireless network device determines whether a corresponding first level security key is received from the home agent in the network in response (operation 620). If the first level security key is received, the wireless network device derives the second level security key (operation 625) and completes roaming domain association with the roaming client (operation 630). If no first level security key is received, the wireless network device de-authenticates the client (operation 635).

If, on the other hand, the disclosed network device determines that the first level security key exists for the roaming client, the disclosed network device will proceed to derive the second level security key (operation 625) and completes roaming domain association with the roaming client (operation 630).

Referring now to FIG. 6B, during operations of a network device acting as a first level key holder in a network (e.g., network_{B}) that a client roams to, the disclosed network device receives a first level security key identifier in an authentication request received from a roaming client (operation 640). Note that, the first level security key identifier is unique to a first level security key corresponding to a first level key holder in a different network (e.g., network_{A}), with which the roaming client was previously associated.

The network device determines a home agent network device in the different network (e.g., a first level key holder in network_{A}) based on the received first level security key identifier (operation 645). Furthermore, the network device requests a corresponding key from the home agent network device in the different network based on received first level security key identifier (operation 650). Subsequently, the network device receives a response from the home agent network device in the different network (operation 655).

Then, the network device determines whether the response from the home agent network device in the different network includes the requested first level security key (operation 658). If not, the network device instructs the second level key holder to de-authenticate (or disassociate) the client (operation 660). If, however, the home agent network device in the different network responds with the requested first level security key, the network device determines whether a re-association phase between the roaming client and the second level key holder is completed (operation 665). If not, the network waits for the re-association phase to complete. Otherwise, the network device transmits the roaming client's IP address and/or MAC address to the home agent network device in the different network (operation 670) to notify the home agent network device that the client identified by the IP address and/or MAC address has roamed to the current network (e.g., network_{B}), and receives an acknowledgement message from the home agent network device (operation 675). Meanwhile, the network device updates its own routing table so that all packets originated from the roaming client will be routed to the home agent network device in the different network (e.g., first level key holder in network_{A}) (operation 680).

In some embodiments, the network device determines another network device (e.g., a first level key holder in network_{A}) based on a received first level key holder identifier by searching a table that stores information about the first level key holders within the roaming domain. The information includes the first level key holder identifiers, MAC addresses and IP addresses of the first level key holders in the networks within the roaming domain. The table can be populated to record 462 in a variety of ways. For example, each time when a new network device joins a roaming domain, the new network device can send a broadcast message in the network layer to the networks in the roaming domain. The broadcast message may include a first level security key holder identifier (e.g., PMK-R0KH ID), a MAC address of the new network device, and an IP address of the new network device. When the other network devices receive the broadcast message, they can store or update the first level security key holder identifier, the MAC address, and IP address of network device in their own records.

In another example, as illustrated in FIG. 6C, one network device in a roaming domain may be elected or configured as a master device. Every time when a new network device acting or capable of acting as a first level key holder joins the roaming domain, the master network device of the roaming domain will receive information corresponding to the first level key holder in a message from the new network device (operation 685). This information will include the first level key holder identifier, its MAC address and its IP address. Then, the master network device can store the information received from first level key holder in a master record, e.g., a table (operation 690) and update other network devices in the roaming domain with the updated master record so that the other controllers can update their own copy of the record (operation 695). In an alternative embodiment, the master network device may be configured with the relevant information about all the first level key holders in the roaming domain.

### System for Leveraging Roaming Domain to Provide L2/L3 Mobility

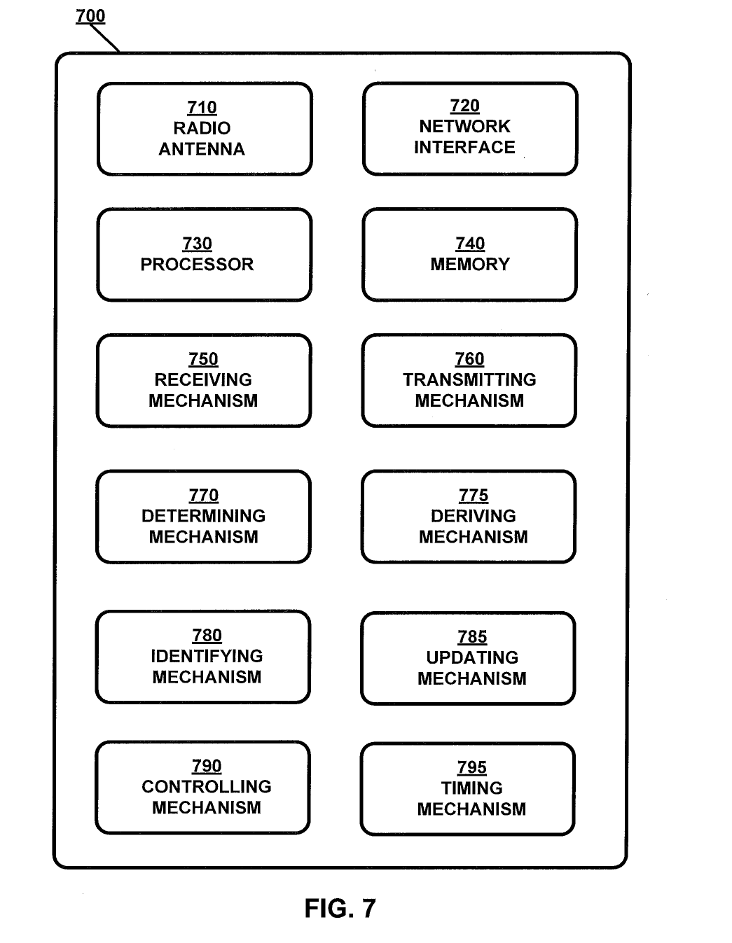

FIG. 7 is a block diagram illustrating a system for leveraging roaming domain to provide data link layer (L2) and network layer (L3) mobility using leveled security keys according to embodiments of the present disclosure.

Operating as a first level security key holder in a first network, network device 700 includes at least one or more radio antennas 710 capable of either transmitting or receiving radio signals or both, or a network interface 720 capable of communicating to a wired or wireless network. Additionally, network device 700 also includes a processor 730 capable of processing computing instructions, and a memory 740 capable of storing instructions and data. Moreover, network device 700 further includes a receiving mechanism 750, a transmitting mechanism 760, a determining mechanism 770, a deriving mechanism 775, an identifying mechanism 780, an updating mechanism 785, a controlling mechanism 790, and a timing mechanism 795, all of which are coupled to processor 730 and memory 740 in network device 700. Network device 700 may be used as a client system, or a server system, or may serve both as a client and a server in a distributed or a cloud computing environment.

Radio antenna 710 may be any combination of known or conventional electrical components for receipt of signaling, including but not limited to, transistors, capacitors, resistors, multiplexers, wiring, registers, diodes or any other electrical components known or later become known.

Network interface 720 can be any communication interface, which includes but is not limited to, a modem, token ring interface, Ethernet interface, wireless IEEE 802.11 interface, cellular wireless interface, satellite transmission interface, or any other interface for coupling network devices.

Processor 730 can include one or more microprocessors and/or network processors. Memory 740 can include storage components, such as, Dynamic Random Access Memory (DRAM), Static Random Access Memory (SRAM), etc.

Receiving mechanism 750 receives one or more network messages via network interface 720 or radio antenna 710 from a wireless client. The received network messages may include, but are not limited to, requests and/or responses, beacon frames, management frames, control path frames, and so on. Each message may comprise one or more data packets, for example, in the form of IP packets.

In some embodiments, receiving mechanism 750 receives a first level security key holder identifier corresponding to a second network device in a second network. The first level security key holder identifier is retrieved from a request received by a third device in the first network, and originated from a client that roams from the second network to the first network. Note that, the first network and the second network belong to a single roaming domain. Also, in some embodiments, the request includes an initial mobility domain association (IMDA) request during a fast basic service set (BSS) transition (FT).

In some embodiments, in order to populate a record that includes correspondence between first level security key holders and network device identifiers, receiving mechanism 750 receives a broadcast message in the network layer from the second network device within a single roaming domain. The broadcast message can include the first level security key holder identifier corresponding to the second network device. In some embodiments, in order to populate a record, receiving mechanism 750 receives another first level security key holder identifier from a new network device that joins the single roaming domain. In some embodiments, after network device 700 notifies the second network device that the client has transitioned from the second network device to the first network device, receiving mechanism 750 receives an acknowledgement from the second network device.

Transmitting mechanism 760 transmits messages, which include, but are not limited to, requests and/or responses, beacon frames, management frames, control path frames, and so on. In some embodiments, transmitting mechanism 760 transmits the first level security key holder identifier to the second network device to request for a first level security key after receiving mechanism 750 receives the first level security key holder identifier. In some embodiments, transmitting mechanism 760 further transmits a second level security key holder identifier corresponding to the second level security key to the third network device.

In some embodiments, when network device 700 is elected or designated as a master device, transmitting mechanism 760 can transmit an updated record to other network devices acting as first level security key holders in a single roaming domain. The updated record includes updates on correspondences between first level security key holder identifiers and first level security key holders in the single roaming domain.

In some embodiments, after a client associates with the first network to which network device 700 belongs, transmitting mechanism 760 can transmit one or more of an Internet Protocol (IP) address and a Media Access Control (MAC) address of the client to the second network device to notify the second network device that the client has transitioned from the second network device to the first network device. In some embodiments, transmitting mechanism 760 will re-transmit the one or more of the IP address and the MAC address of the client to the second network device in response to a preset timer expiring.

Determining mechanism 770, according to embodiments of the present disclosure, determines whether the first level security key corresponding to the first level security key holder identifier is received from a second network device, which acts as a first level key holder in a second network. Note that, the second network is different from the network to which network device 700 belongs but is within the same roaming domain. Also, the first level key identifier is retrieved from a request received by a third device in the first network and originated from a client that roams from the second network to the first network.

Deriving mechanism 775 generally derives leveled security keys for the wireless client. For example, deriving mechanism 775 can derive a second level security key based at least in part on the first level security key if receiving mechanism 750 receives the first level security key corresponding to the first level security key holder identifier.

Identifying mechanism 780 generally identifies network devices in networks in the single roaming domain. For example, in some embodiments, identifying mechanism 780 can identify the second network device corresponding to the received first level security key holder identifier by checking a record that includes correspondence between first level security key holder identifiers and network device identifiers in the single roaming domain.

Updating mechanism 785 generally updates a record or a table. The record may include correspondences between first level security key holder identifiers and network device identifiers in one or more roaming domains. Specifically, updating mechanism 785 can update the record based on a broadcast message in network layer received from another network device in the same roaming domain as the roaming domain that network device 700 belongs to. In addition, when a new network device joins the same roaming domain, updating mechanism 785 can update the record based at least in part on a first level security identifier received from the new network device.

In addition, updating mechanism 785 also can update a routing table. For example, after identifying mechanism 780 identifies the network device corresponding to the received first level security key holder identifier, network device 700 will identify itself as a foreign agent. Therefore, updating mechanism 785 will update its routing table to redirect packets with a source address matching the IP address or the MAC address of client to the second network device. Note that, the second network device will also update its routing table to redirect packets with a destination address corresponding to the client's IP address or MAC address to the first network device.

Controlling mechanism 790 generally controls other network devices in the network to take an action or not to take an action that involves one or more wireless clients or devices. For example, controlling mechanism 790 can instruct a third network device, e.g., an access point, to de-authenticate the client or disassociate with the client if receiving mechanism 750 receives no first level security key corresponding to the first level security key holder identifier.

Timing mechanism 795 generally operates a timer that can be used in conjunction with other mechanisms in network device 700. For example, when transmitting mechanism 760 transmits one or more of the IP address and the MAC address of the client to the second network device, timing mechanism 795 initiates a timer. In some embodiments, if when the time expires, receiving mechanism 750 has not received an acknowledgement from the second network device, transmitting mechanism 760 will re-transmit the one or more of the IP address and the MAC address of the client to the second network device.

Therefore, receiving mechanism 750, transmitting mechanism 760, determining mechanism 770, deriving mechanism 775, identifying mechanism 780, updating mechanism 785, controlling mechanism 790, and timing mechanism 795 often collectively operate with each other to provide data link layer (L2) and network layer (L3) mobility using leveled security keys.

According to embodiments of the present disclosure, network services provided by wireless network device 700, solely or in combination with other wireless network devices, include, but are not limited to, an Institute of Electrical and Electronics Engineers (IEEE) 802.1X authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A method comprising:
receiving, by a first network device acting as a first level security key holder in a first network, a first level security key holder identifier corresponding to a second network device in a second network, the first level security key holder identifier is retrieved from a request originating from a client that roams from the second network to the first network, wherein the first network and the second network belong to a single roaming domain; and
transmitting, by the first network device, the first level security key holder identifier to the second network device to request a first level security key.

2. The method of claim 1, further comprising:
determining, by the first network device, whether the first level security key corresponding to the first level security key holder identifier is received;
in response to receiving the first level security key corresponding to the first level security key holder identifier, deriving, by the first network device, a second level security key based at least in part on the first level security key; and
transmitting, by the first network device, a second level security key identifier corresponding to the second level security key to a third network device.

3. The method of claim 1, further comprising:
identifying, by the first network device, the second network device corresponding to the received first level security key holder identifiers by checking a record that includes correspondence between first level security key holder identifiers and network device identifiers in the single roaming domain.

4. The method of claim 3, further comprising:
receiving, by the first network device, a broadcast message in network layer from the second network device within the single roaming domain, the broadcast message comprising the first level security key holder identifier corresponding to the second network device; and
updating, by the first network device, the record based on the broadcast message.

5. The method of claim 3, further comprising:
receiving, by the first network device, another first level security key holder identifier from a new network device that joins the single roaming domain;
updating, by the first network device, the record based at least in part on the received first level security key holder identifier; and
transmitting, by the first network device, the updated record to other network devices acting as first level security key holders in the single roaming domain.

6. The method of claim 1, further comprising:
transmitting, by the first network device, one or more of an Internet Protocol (IP) address and a Media Access Control (MAC) address of the client to the second network device to notify the second network device that the client has transitioned from the second network device to the first network device; and
receiving, by the first network device, an acknowledgement from the second network device.

7. The method of claim 6, further comprising:
updating, by the first network device, a routing table to redirect packets with a source address matching the IP address or the MAC address of client to the second network device,
wherein the second network device updates its routing table to redirect packets with a destination address corresponding to the client's IP address or MAC address to the first network device.

8. The method of claim 6, further comprising:
initiating, by the first network device, a timer in response to transmitting the one or more of the IP address and the MAC address of the client to the second network device; and
in response to the timer expiring, re-transmitting, by the network device, the one or more of the IP address and the MAC address of the client to the second network device.

9. The method of claim 1, further comprising:
in response to no first level security key corresponding to the first level security key holder identifier being received, instructing a third network device that receives the request to de-authenticate the client or disassociate with the client.

10. The method of claim 1, wherein the request comprises an initial mobility domain association request during a fast basic service set (BSS) transition (FT).

11. The method of claim 1, wherein the roaming domain comprises a collection of network entities capable of discovering, sharing, or extending the client's network connectivity state.

12. A network device acting as a first level security key holder in a first network, the network device comprising:
a processor;
a memory;
a receiving mechanism operating with the processor, the receiving mechanism to receive a first level security key holder identifier corresponding to a second network device in a second network, the first level security key holder identifier is retrieved from a request originating from a client that roams from the second network to the first network, wherein the first network and the second network belong to a single roaming domain; and
a transmitting mechanism operating with the processor, the transmitting mechanism to transmit the first level security key holder identifier to the second network device to request for a first level security key.

13. The network device of claim 12, further comprising:
a determining mechanism operating with the processor, the determining mechanism to determine whether the first level security key corresponding to the first level security key holder identifier is received; and
a deriving mechanism operating with the processor, the deriving mechanism to derive a second level security key based at least in part on the first level security key in response to the receiving mechanism receiving the first level security key corresponding to the first level security key holder identifier;
wherein the transmitting mechanism further to transmit a second level security key identifier corresponding to the second level security key to a third network device adapted to receive the request from the client.

14. The network device of claim 12, further comprising:
an identifying mechanism operating with the processor, the identifying mechanism to identify the second network device corresponding to the received first level security key holder identifier by checking a record that includes correspondence between first level security key holder identifiers and network device identifiers in the single roaming domain.

15. The network device of claim 14,
wherein the receiving mechanism further to receive a broadcast message in network layer from the second network device within the single roaming domain, the broadcast message comprising the first level security key holder identifier corresponding to the second network device; and
wherein the network device further comprises an updating mechanism operating with the processor, the updating mechanism to update the record based on the broadcast message.

16. The network device of claim 14,
wherein the receiving mechanism further to receive another first level security key holder identifier from a new network device that joins the single roaming domain;
wherein the updating mechanism further to update the record based at least in part on the received first level security key holder identifier; and
wherein the transmitting mechanism further to transmit the updated record to other network devices acting as first level security key holders in the single roaming domain.

17. The network device of claim 12,
wherein the transmitting mechanism further to transmit one or more of an Internet Protocol (IP) address and a Media Access Control (MAC) address of the client to the second network device to notify the second network device that the client has transitioned from the second network device to the first network device; and
wherein the receiving mechanism further to receive an acknowledgement from the second network device.

18. The network device of claim 17, further comprising:
an updating mechanism operating with the processor, the updating mechanism to update a routing table to redirect packets with a source address matching the IP address or the MAC address of client to the second network device,
wherein the second network device updates its routing table to redirect packets with a destination address corresponding to the client's IP address or MAC address to the first network device.

19. The network device of claim 17, further comprising:
a timing mechanism operating with the processor, the timing mechanism to initiate a timer in response to transmitting the one or more of the IP address and the MAC address of the client to the second network device; and
wherein the transmitting mechanism to re-transmit the one or more of the IP address and the MAC address of the client to the second network device in response to the timer expiring.

20. The network device of claim 12, further comprising:
a controlling mechanism operating with the processor, the controlling mechanism to instruct a third network device, adapted to receive the request from the client, to de-authenticate the client or disassociate with the client in response to no first level security key corresponding to the first level security key holder identifier being received.

21. The network device of claim 12, wherein the request comprises an initial mobility domain association request during a fast basic service set (BSS) transition (FT).

22. The network device of claim 12, wherein the roaming domain comprises a collection of network entities capable of discovering, sharing, or extending the client's network connectivity state.

22. A non-transitory computer-readable storage medium storing embedded instructions that are executed by one or more mechanisms implemented within a network device acting as a first level security key holder in a first network to perform a plurality of operations comprising:
receiving a first level security key holder identifier corresponding to a second network device in a second network, wherein the first level security key holder identifier is retrieved from a request received by a third device in the first network and originated from a client that roams from the second network to the first network, and wherein the first network and the second network belong to a single roaming domain; and
transmitting the first level security key holder identifier to the second network device to request for a first level security key.
